(19) United States
(12) Patent Application Publication
(10) Pub. No.: US 2024/0313935 A1
(43) Pub. Date: Sep. 19, 2024

(54) INFORMATION PROCESSING METHOD AND APPARATUS, AND COMMUNICATION DEVICE AND STORAGE MEDIUM

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 18/576,946

(22) PCT Filed: Jul. 6, 2021
(86) PCT No.: PCT/CN2021/104645

§ 371 Date: Jan. 5, 2024

(51) Int. Cl. H04L 5/14; H04W 8/02; H04W 52/36

(52) U.S. Cl. CPC H04L 5/14; H04W 8/02; H04W 52/367

(57) ABSTRACT

The present disclosure provides an information processing method and apparatus, and a communication device and a storage medium. The information processing method is performed by User Equipment (UE), and includes: sending first information of the UE, where the first information is used for configuration by a network device for a working mode of the UE, and the working mode includes a full duplexing mode.

### CROSS-REFERENCE TO RELATED APPLICATIONS

This application is a national stage of international PCT Application No. PCT/CN2021/104645 filed on Jul. 6, 2021, the entire contents of which are incorporated herein by reference.

### TECHNICAL FIELD

The present disclosure relates to but is not limited to the field of communication technologies, and in particular to information processing methods and apparatuses, communication devices, and storage media.

### BACKGROUND

In the related arts, for example, in the 4th-generation mobile communication (4G) or 5th-generation mobile communication (5G) system, there are two major duplexing modes, one of which is Time Division Duplexing (TDD) and the other is Frequency Division Duplexing (FDD). The duplexing mode is related to the specific frequency band and radio frequency implementation. In the existing standard, a duplexing mode, for example, the TDD mode or FDD mode may be indicated for a specific frequency band. The above two duplexing modes are used mainly for isolating interference between uplink and downlink. However, along with continuous improvement of device performance and baseband processing algorithm, a full duplexing mode has become a hot spot in the current researches.

### SUMMARY

The embodiments of the present disclosure provide an information processing method and apparatus, a communication device and a storage medium.

According to a first aspect of embodiments of the present disclosure, there is provided an information processing method, which is performed by User Equipment (UE). The method includes: sending first information of the UE, where the first information is used at least for configuration by a network device for a working mode of the UE, and the working mode includes at least a full duplexing mode.

According to a second aspect of embodiments of the present disclosure, there is provided an information processing method, which is performed by a network device. The method includes: receiving first information of User Equipment (UE); and determining configuration for a working mode of the UE based on the first information; where the working mode includes at least a full duplexing mode.

According to a third aspect of embodiments of the present disclosure, there is provided an information processing apparatus, which is applied to User Equipment (UE). The apparatus includes: a first sending module, configured to send first information of the UE, where the first information is used at least for configuration by a network device for a working mode of the UE, and the working mode includes at least a full duplexing mode.

According to a fourth aspect of embodiments of the present disclosure, there is provided an information processing apparatus, which is applied to a network device. The apparatus includes: a second receiving module, configured to receive first information of User Equipment (UE); and a second determining module, configured to determine configuration for a working mode of the UE based on the first information; where the working mode includes at least a full duplexing mode.

According to a fifth aspect of embodiments of the present disclosure, there is provided a communication device, including: a processor; and a memory storing processor executable instructions; where the processor is configured to run the executable instructions to perform the information processing method in any one of the above embodiments of the present disclosure.

According to a sixth aspect of embodiments of the present disclosure, there is provided a computer storage medium storing computer executable programs, the computer executable programs are executed by a processor to perform the information processing method in any one of the above embodiments of the present disclosure.

The technical solutions provided by the embodiments of the present disclosure can bring the following beneficial effects.

In the embodiments of the present disclosure, the UE sends the first information of the UE, where the first information is used at least for configuration by the network device for the working mode of the UE and the working mode at least includes a full duplexing mode. Therefore, in the embodiments of the present disclosure, the UE may report the first information of the UE duplexing mode to the network device, such that the network device can determine the UE works in a proper working mode based on the first information. For example, the network device can determine whether the UE works in the full duplexing mode. If it is determined that the UE works in the full duplexing mode, the UE will be enabled to improve the frequency resource utilization rate and reduce the service delay.

It should be understood that the above general descriptions and subsequent detailed descriptions are merely illustrative and explanatory rather than limiting of the present disclosure.

### BRIEF DESCRIPTION OF DRAWINGS

To illustrate the technical solutions in the embodiments of this disclosure more clearly, the drawings used in the embodiments will be briefly described below.

FIG. 1 is a structural schematic diagram illustrating a wireless communication system.

FIG. 2 is a schematic diagram illustrating a time division duplexing according to an exemplary embodiment of the present disclosure.

FIG. 3 is a schematic diagram illustrating a frequency division duplexing according to an exemplary embodiment of the present disclosure.

FIG. 4 is a schematic diagram illustrating a full duplexing mode according to an exemplary embodiment of the present disclosure.

FIG. 5 is a flow diagram illustrating an information processing method according to an exemplary embodiment of the present disclosure.

FIG. 6 is a flow diagram illustrating an information processing method according to an exemplary embodiment of the present disclosure.

FIG. 7 is a flow diagram illustrating an information processing method according to an exemplary embodiment of the present disclosure.

FIG. 8 is a flow diagram illustrating an information processing method according to an exemplary embodiment of the present disclosure.

FIG. 9 is a flow diagram illustrating an information processing method according to an exemplary embodiment of the present disclosure.

FIG. 10 is a flow diagram illustrating an information processing method according to an exemplary embodiment of the present disclosure.

FIG. 11 is a flow diagram illustrating an information processing method according to an exemplary embodiment of the present disclosure.

FIG. 12 is a block diagram illustrating an information processing apparatus according to an exemplary embodiment of the present disclosure.

FIG. 13 is a block diagram illustrating an information processing apparatus according to an exemplary embodiment of the present disclosure.

FIG. 14 is a block diagram illustrating an information processing apparatus according to an exemplary embodiment of the present disclosure.

FIG. 15 is a block diagram illustrating a UE according to an exemplary embodiment of the present disclosure.

FIG. 16 is a block diagram illustrating a base station according to an exemplary embodiment of the present disclosure.

### DETAILED DESCRIPTION

Exemplary embodiments will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terms used in the present disclosure are used for the purpose of describing particular embodiments only, and are not intended to limit the present disclosure. Terms determined by “a,” “the” and “said” in their singular forms in the present disclosure and the appended claims are also intended to include plurality, unless clearly indicated otherwise in the context. It should also be understood that the term “and/or” as used herein refers to and includes any and all possible combinations of one or more of the associated listed items.

It is to be understood that, although the terms “first,” “second,” “third,” and the like may be used in the present disclosure to describe various information, such information should not be limited to these terms. These terms are only used to distinguish one category of information from another. For example, without departing from the scope of the present disclosure, first information may be referred as second information; and similarly, the second information may also be referred as the first information. Depending on the context, the term “if” as used herein may be interpreted as “when” or “upon” or “in response to determining”. At present, the full duplexing mode has been partially applied at the network device sides and has become an evolution direction of the 5G New Radio (NR). Because the User Equipment (UE) is limited by the device performance, uplink-downlink isolation has become a bottleneck. But, under some conditions, the full duplexing mode can also be applied in the UE.

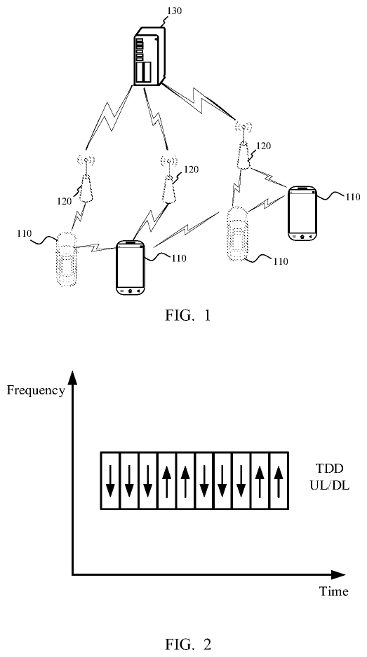

FIG. 1 is a structural schematic diagram illustrating a wireless communication system according to an embodiment of the present disclosure. As shown in FIG. 1, the wireless communication system is a communication system based on cellular mobile communication technology and can include several user equipment 110 and several base stations 120.

The user equipment 110 may be a device directed toward a user to provide voice, and/or data connectivity. The user equipment 110 may communicate with one or more core networks through a radio access network (RAN). The user equipment 110 may be user equipment of internet of things, such as a sensor device, a mobile phone, (or called cellular phone), and a computer having user equipment of internet of things, such as a fixed, portable, pocket-sized, handheld, or computer-inbuilt or vehicle-mounted apparatus, such as station (STA), subscriber unit, subscriber station, mobile station, mobile, remote station, access point, remote terminal, access terminal, user terminal, user agent, user device, or user equipment. Optionally, the user equipment 110 may also be a device of an unmanned aerial vehicle, or a vehicle-mounted device, for example, may be a trip computer having wireless communication function, or a wireless device externally connected to a trip computer. Optionally, the user equipment 110 may be a roadside device, for example, may be a road lamp, signal lamp or another roadside device having wireless communication function.

The base station(s) 120 may be a network side device in a wireless communication system. The wireless communication system may be a 4th-generation mobile communication technology (4G) system, which is also called Long Term Evolution (LTE) system. Optionally, the wireless communication system may also be a 5G system, which is also called new radio (NR) system or 5G NR system. Optionally, the wireless communication system may also be a next generation system of the 5G system. An access network in the 5G system may be referred to as New Generation-Radio Access Network (NG-RAN).

The base station 120 may be an evolved base station (eNB) employed in the 4G system. Optionally, the base station 120 may also be a base station (gNB) adopting centralized distributed architecture in the 5G system. When adopting the centralized distributed architecture, the base station 120 usually includes a central unit (CU) and at least two distributed units (DU). In the central unit, protocol stacks of a Packet Data Convergence Protocol (PDCP) layer, a Radio Link Control (RLC) layer and a Media Access Control (MAC) layer are disposed; in the distributed unit, a physical (PHY) layer protocol stack is disposed. The specific implementations of the base station 120 are not limited in the embodiments of the present disclosure.

Wireless connection can be established between the base station 120 and the user equipment 110 through a wireless air interface. In different implementations, the wireless air interface is a wireless air interface based on the fourth generation mobile communication network technology (4G) standard; or, the wireless air interface is a wireless air interface based on the fifth generation mobile communication network technology (5G) standard, for example, the wireless air interface is a new air interface; or, the wireless air interface may also be a wireless air interface based on a next generation mobile communication network technology standard of 5G.

In some embodiments, end to end (E2E) connection may also be established between the multiple pieces of user equipment 110. For example, in the scenarios of vehicle to vehicle (V2V) communication, vehicle to Infrastructure (V2I) communication, and vehicle to pedestrian (V2P) communication and the like in vehicle to everything (V2X) communication.

Herein, the user equipment may be a terminal device in the following embodiments.

In some embodiments, the wireless communication system of FIG. 1 may further include a network management device 130.

Several base stations 120 are connected with the network management device 130 respectively. The network management device 130 may be a core network device in the wireless communication system, for example, the network management device 130 may be a Mobility Management Entity (MME) in an Evolved Packet Core (EPC). Alternatively, the network management device may also be another core network device, such as Serving GateWay (SGW), Public Data Network GateWay (PGW), Policy and Charging Rules Function (PCRF), or Home Subscriber Server (HSS). The implementation form of the network management device 130 is not limited in the embodiments of the present disclosure.

In order to better understand the technical solution of each embodiment of the present disclosure, the duplexing mode in the related arts will be partially described herein.

In an embodiment, as shown in FIG. 2, there is provided a duplexing mode of Time Division Duplexing (TDD). The time division duplexing allows only uplink (UL) transmission or downlink (DL) transmission in one slot. Additionally, the DL transmission and the UL transmission can use the entire spectrum bandwidth.

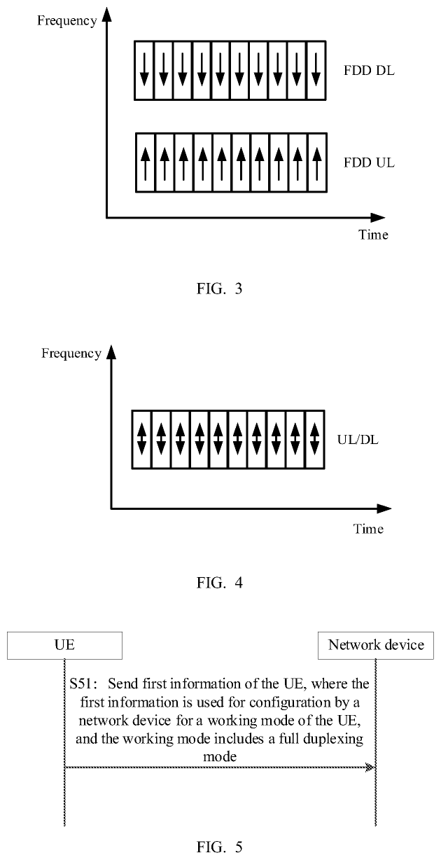

In an embodiment, as shown in FIG. 3, there is provided a duplexing mode of Frequency Division Duplexing (FDD). The frequency division duplexing divides a spectrum bandwidth into two parts, which are allocated to the UL and DL respectively. The UL and DL can perform simultaneous transmission but cannot use the entire spectrum bandwidth.

In an embodiment, as shown in FIG. 4, there is provided a duplexing mode of full duplexing. The full duplexing refers to that the DL and UL transmissions can be performed at the same time, and the DL and UL transmissions can use the entire spectrum bandwidth.

As shown in FIG. 5, an embodiment of the present disclosure provides an information processing method, which is performed by User Equipment (UE). The method includes step S51.

At step S51, first information of the UE is sent. Where the first information is used at least for configuration by a network device for a working mode of the UE, and the working mode at least includes a full duplexing mode.

In an embodiment, the UE may be any mobile terminal or fixed terminal. For example, the UE may be but not limited to a smart phone, a computer, a server, a wearable device, a game console, or a multimedia device or the like.

The information processing method provided by the embodiments of the present disclosure is performed by the UE, which includes: sending first information of the UE to a network device, where the first information is used at least for configuration by the network device for a working mode of the UE and the working mode at least includes a full duplexing mode.

In an embodiment, the network device may be an access network device or a core network device. In an embodiment, the access network device may be but not limited to a base station. The base station may be an interface device by which the UE accesses the internet. The base station may be any type of base station, for example, the base station may be a 3G base station, a 4G base station, a 5G base station or another evolved base station.

In an embodiment, the core network device may be but not limited to any physical entity or logical entity in the core network; for example, the core network device may be a mobility management entity or a service gateway or the like.

Taking a base station as an example, sending information to the core network device by the UE may refer to that the UE sends information to the base station which then forwards the information to the core network device by the base station. Receiving information from the core network device by the UE may refer to that the core network device firstly sends information to the base station and the UE then receives information forwarded by the base station from the core network device.

In an embodiment, the working mode of the UE includes but not limited to one of: a full duplexing mode and a non-full duplexing mode. The non-full duplexing mode herein includes but not limited to one of: a time division duplexing mode, a frequency division duplexing mode or a simplex mode.

In an embodiment, the first information may include information allowing the full duplexing mode or disallowing the full duplexing mode; or, the first information may be indication information for indicating allowing the full duplexing mode or disallowing the full duplexing mode. Illustratively, the UE sends the first information including allowing the full duplexing mode to the network device. Thus, the network device may determine configuration of the UE working in the full duplexing mode based on the first information. Illustratively, the UE sends the first information including disallowing the full duplexing mode to the network device. Thus, the network device may determine configuration of the UE incapable of working in the full duplexing mode based on the first information, or determine configuration of the UE working in the non-full duplexing mode based on the first information.

In an embodiment of the present disclosure, the first information of the UE may be sent to the network device by the UE. The first information is used at least for configuration by the network device for the working mode of the UE, and the working mode at least includes the full duplexing mode. Therefore, in an embodiment of the present disclosure, the first information of the UE duplexing mode may be reported to the network device by the UE, such that the network device can determine the UE works in a proper working mode based on the first information. Hence, the network device can determine whether the UE works in the full duplexing mode. Further, if it is determined that the UE works in the full duplexing mode, the UE can be enabled to improve the frequency resource utilization rate and reduce the service delay. In other words, the when the UE works in the full duplexing mode, the frequency resource utilization rate and reducing the service delay are both improved.

In an embodiment, the first information is used to indicate a transmission power supported by the UE working in the working mode. Illustratively, the UE sends the first information of the UE to the network device, where the first information is used for configuration by the network device for the working mode of the UE, and used to indicate the transmission power supported by the UE in the working mode. The working mode at least includes a full duplexing mode. Therefore, in an embodiment of the present disclosure, the working mode allowed by the UE and the transmission power corresponding to the working mode can be sent to the network device by the UE. In this case, the network device can further accurately determine the configuration for the working mode of the UE based on the working mode allowed by the UE and the transmission power corresponding to the working mode.

In an embodiment, the first information indicates at least one of: a transmission power supported by the UE in the full duplexing mode; or a transmission power supported by the UE in the non-full duplexing mode. Illustratively, the UE sends the first information of the UE to the network device, where the first information is used for configuration by the network device for the working mode of the UE, to indicate the transmission power supported by the UE working in the full duplexing mode, and/or to indicate the transmission power supported by the UE working in the non-full duplexing mode.

In an embodiment, the transmission power supported by the UE in the full duplexing mode may be less than or equal to a power threshold; and the transmission power supported by the UE in the non-full duplexing mode may be greater than the power threshold. The power threshold herein may be a cutoff value supporting the full duplexing mode and the non-full duplexing mode. Illustratively, the power threshold may be −35 dBm. Certainly, in other embodiments, the power threshold may be another value. Further, in other embodiments, the first information may indicate a transmission power supported by another working mode.

In an embodiment, the first information may include a transmission power or power information of the UE. The power information herein may be a transmission power, and the transmission power herein may indicate a current transmission power of the UE.

Illustratively, the UE sends the first information to the network device, where the first information is shown as in Table 1.

TABLE 1

| Full duplexing mode | Power information |
|---|---|
| Allowed | ≤−35 dBm |
| Disallowed | >−35 dBm |

As shown in Table 1, the first information may be the information allowing the full duplexing mode and the power information corresponding to the full duplexing mode, or the information disallowing the full duplexing mode and the power information corresponding to disallowing the full duplexing mode. A first preset field of the first information herein carries the information allowing the full duplexing mode or the information disallowing the full duplexing mode. A second preset field of the first information herein carries the power information corresponding to allowing the full duplexing mode or the power information corresponding to disallowing the full duplexing mode. Thus, in an embodiment of the present disclosure, the UE can report whether to allow the full duplexing mode and the power information corresponding to whether to allow the full duplexing mode.

Illustratively, if the UE sends to the network device the first information allowing the full duplexing mode and the transmission power thereof being less than or equal to the power threshold, the network device may determine the configuration of the UE working in the full duplexing mode. If the UE sends to the network device the first information allowing the full duplexing mode and the transmission power thereof being greater than the power threshold, the network device may determine the configuration of the UE working in the non-full duplexing mode. If the UE sends to the network device the first information disallowing the full duplexing mode and the transmission power thereof being greater than the power threshold, the network device may determine the configuration of the UE working in the non-full duplexing mode.

When the transmission power of the UE is less than or equal to the power threshold, after passing through a duplexer between a reception link and a transmission link, the transmission power of the UE is very small relative to the reception power of the UE. Thus, isolation between the reception link and the transmission link can avoid interference between uplink and downlink transmissions as possible. When the transmission power is less than or equal to the power threshold, the full duplexing mode can be applied in the UE. The UE working in the full duplexing mode can increase the frequency resource utilization rate and reduce the service delay.

When the transmission power of the UE is very large, since the reception power of the UE for receiving from the network device is transmitted from a relatively distant network device, the reception power of the UE is relatively small. For example, the transmission power may be up to dozens of watts and the reception power is only several picowatts. Even if there is a duplexer between the reception link and the transmission link, the leakage of the duplexer may dope a transmission signal into a reception signal, resulting in large interference of the uplink and downlink transmissions. Thus, when the transmission power is greater than the power threshold, it is not appropriate for the UE to use the full duplexing mode. When the UE works in the non-full duplexing mode, the interference between the uplink and downlink transmissions can be isolated, making the uplink and downlink data transmission more accurate.

In an embodiment of the present disclosure, the UE can send the first information allowing, by the UE, the full duplexing mode and indicating the transmission power supported by the full duplexing mode, or the first information allowing the non-full duplexing mode and indicating the transmission power supported by the non-full duplexing mode. Hence, the network device may further determine the configuration for the working mode of the UE accurately based on the first information.

The information processing method provided by the embodiments of the present disclosure is performed by the UE, which includes: sending first information by a signaling. Illustratively, the UE sends the first information by a Radio Resource Control (RRC) signaling or a Service Request signaling or the like. The RRC signaling herein may be an RRC connection request or an RRC reconnection request. Thus, in an embodiment of the present disclosure, there is no need to add a signaling for sending the first information, saving the overhead of the system signaling.

It should be noted that those skilled in the arts can understand that the method provided by the embodiments of the present disclosure can be executed separately or together with some methods in the embodiments of the present disclosure or with some methods in the related arts.

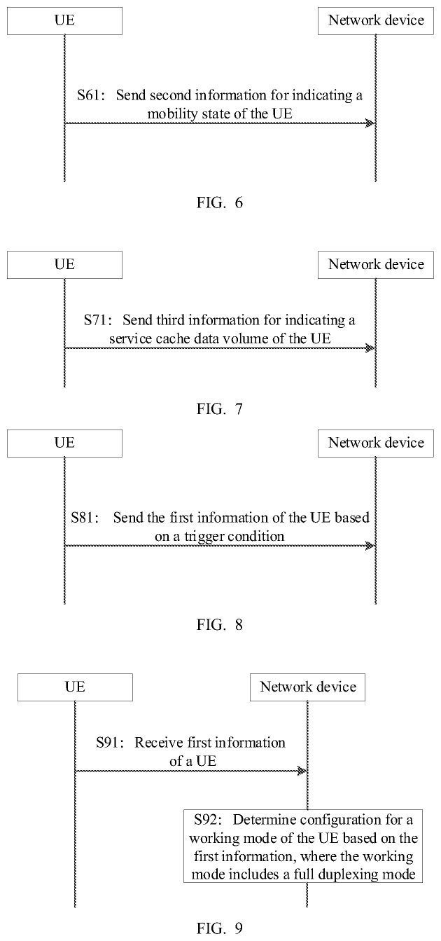

As shown in FIG. 6, an embodiment of the present disclosure provides an information processing method, which is performed by the UE. The method includes step S61.

At step S61, second information for indicating a mobility state of the UE is sent.

In some embodiments of the present disclosure, the first information is the first information in the step S51 of FIG. 5.

In an embodiment, the mobility state of the UE includes a first mobility state, and/or a second mobility state. In an embodiment, the UE in the first mobility state has a moving rate less than a moving rate of the UE in the second mobility state, and the moving rate of the UE in the first mobility state is less than a rate threshold. In an embodiment, the UE in the first mobility state may be a relatively stationary UE or a UE with a relatively low mobility, and the UE in the second mobility state may be a UE with a relatively high mobility. In an embodiment, the mobility state of the UE may be determined based on a change value of a signal strength of a received reference signal.

The information processing method provided by the embodiments of the present disclosure is performed by the UE, which includes: if the change value of the signal strength of the reference signal received by the UE within a preset time range is less than or equal to a threshold, determining that the UE is in the first mobility state.

The information processing method provided by the embodiments of the present disclosure is performed by the UE, which includes: if the change value of the signal strength of the reference signal received by the UE within the preset time range is greater than the threshold, determining that the UE is in the second mobility state.

Illustratively, the UE obtains a maximum value of the signal strength of the reference signal received within the preset time range and a minimum value of the signal strength of the reference signal received within the preset time range, determines a difference between the maximum value and the minimum value; and determines whether the difference is greater than a threshold. If the difference is less than or equal to the threshold, it is determined that the UE is in the first mobility state; if the difference is greater than the threshold, it is determined that the UE is in the second mobility state. Therefore, in an embodiment of the present disclosure, the mobility state of the UE can be accurately determined. In this way, after obtaining the mobility state of the UE, the network device can further configure a proper working mode for the UE based on the mobility state of the UE.

In an embodiment, the second information and the first information are used for configuration by the network device for the working mode of the UE.

Illustratively, the UE sends the first information and the second information to the network device, where the first information includes information allowing the full duplexing mode and the second information indicates that the UE is in the first mobility state. Thus, the network device can determine the configuration of the UE working in the full duplexing mode based on the first information and the second information.

Illustratively, the UE sends the first information and the second information to the network device, where the first information includes information allowing the full duplexing mode and the second information indicates that the UE is in the second mobility state. Thus, the network device can determine the configuration of the UE working in the non-full duplexing mode based on the first information and the second information.

Illustratively, the UE sends the first information and the second information to the network device, where the first information includes information disallowing the full duplexing mode and the second information indicates that the UE is in the second mobility state. Thus, the network device can determine the configuration of the UE working in the non-full duplexing mode based on the first information and the second information.

Illustratively, the UE sends the first information and the second information to the network device, where the first information includes information allowing the full duplexing mode and indicating the transmission power supported by the full duplexing mode. If the second information indicates that the UE is in the first mobility state, the network device may determine the configuration of the UE working in the full duplexing mode based on the first information and the second information; if the second information indicates that the UE is in the second mobility state, the network device may determine the configuration of the UE working in the non-full duplexing mode based on the first information and the second information.

In an embodiment of the present disclosure, the UE can send the second information for indicating the mobility state of the UE, such that the network device can determine the configuration for the working mode of the UE based on the first information and the second information. For example, the network device can determine the configuration for the working mode of the UE based on the first information including the information whether allowing the full duplexing mode and the second information indicating the mobility state (the first mobility state or the second mobility state). For another example, the network device can determine the configuration for the working mode of the UE based on the first information including the information indicating the transmission power and whether allowing the full duplexing mode and the second information indicating the mobility state. Hence, the configuration of whether the UE works in the full duplexing mode can be determined more accurately.

In an embodiment, the UE may send the second information by a signaling. Illustratively, the UE may send the second information by an RRC signaling or a service request signaling. The RRC signaling herein may be an RRC connection request or an RRC reconnection request or the like. Thus, in the embodiments of the present disclosure, there is no need to add a signaling for sending the second information, saving the overhead of the system signaling.

It should be noted that those skilled in the arts can understand that the method provided by the embodiments of the present disclosure can be executed separately or together with some methods in the embodiments of the present disclosure or with some methods in the related arts, and thus are not included herein.

As shown in FIG. 7, an embodiment of the present disclosure provides an information processing method, which is performed by the UE. The method includes step S71.

At step S71, third information for indicating a service cache data volume of the UE is sent.

In some embodiments of the present disclosure, the first information is the first information in the step S51 of FIG. 5.

In an embodiment, the third information may indicate one of: a service cache data volume greater than or equal to a preset data volume; or a service cache data volume less than the preset data volume.

In an embodiment, the third information and the first information are used for configuration by the network device for the working mode of the UE.

Illustratively, the UE sends the first information and the third information to the network device, where the first information includes information allowing the full duplexing mode, and the third information is used to indicate the service cache data volume of the UE is greater than or equal to the preset data volume. Thus, the network device can determine the configuration of the UE working in the full duplexing mode based on the first information and the third information.

Illustratively, the UE sends the first information and the third information to the network device, where the first information includes information allowing the full duplexing mode, and the third information is used to indicate the service cache data volume of the UE is less than the preset data volume. Thus, the network device can determine the configuration of the UE working in the non-full duplexing mode based on the first information and the third information.

Illustratively, the UE sends the first information and the third information to the network device, where the first information includes information disallowing the full duplexing mode, and the third information is used to indicate the service cache data volume of the UE is less than the preset data volume. Thus, the network device can determine the configuration of the UE working in the non-full duplexing mode based on the first information and the third information.

In the embodiments of the present disclosure, if the service cache data volume of the UE is greater than or equal to the preset data volume, namely, if the data volume to be cached for the UE executing service is relatively large, it can be determined that the UE works in the full duplexing mode. Thus, the UE can complete service as soon as possible and reduce the service delay. If the service cache data volume of the UE is less than the preset data volume, namely, if the data volume to be cached for the UE executing service is relatively small, it can be determined that the UE can complete service as soon as possible without working in the full duplexing mode. Thus, the UE can work in the non-full duplexing mode to reduce interference of the uplink and downlink transmissions.

In an embodiment, the third information, the second information (which may or may not be the second information in the step S61 of FIG. 6) and the first information are used for configuration by the network device for the working mode of the UE.

Illustratively, the UE sends the first information, the second information and the third information to the network device. Where the first information includes information allowing the full duplexing mode and indicates that the transmission power of the UE is less than or equal to the power threshold, the second information indicates that the UE is in the first mobility state, and the third information indicates that the service cache data volume of the UE is greater than the preset data volume. Thus, the work device can determine the configuration of the UE working in the full duplexing mode based on the first information, the second information and the third information.

Illustratively, the UE sends the first information, the second information and the third information to the network device. Where the first information includes information allowing the full duplexing mode and indicates that the transmission power of the UE is greater than the power threshold, the second information indicates that the UE is in the second mobility state, and the third information indicates that the service cache data volume of the UE is less than the preset data volume. Thus, the work device can determine the configuration of the UE working in the non-full duplexing mode based on the first information, the second information and the third information.

In an embodiment of the present disclosure, contents of the first information, the second information and the third information can be combined together for the network device to determine the configuration for the working mode of the UE. For example, when the first information includes information allowing the full duplexing mode and indicates that the transmission power of the UE is less than or equal to the power threshold, and the second information indicates that the UE is in the first mobility state, and the third information indicates that the service cache data volume of the UE is greater than the preset data volume, it can be determined that it is very appropriate for the UE to work in the full duplexing mode. Thus, in an embodiment of the present disclosure, the working mode in which the UE works properly can be more accurately determined based on the first information, the second information and the third information.

In an embodiment, the UE may send the third information by a signaling. Illustratively, the UE may send the third information by an RRC signaling or a service request signaling or the like. Thus, in an embodiment of the present disclosure, there is no need to add a signaling for sending the third information, saving the overhead of the system signaling.

It should be noted that those skilled in the arts can understand that the method provided by the embodiments of the present disclosure can be executed separately or together with some methods in the embodiments of the present disclosure or with some methods in the related arts, and are not included herein.

As shown in FIG. 8, an embodiment of the present disclosure provides an information processing method, which is performed by the UE. The method includes step S81.

At step S81, the first information of the UE is sent based on a trigger condition.

In some embodiments of the present disclosure, the first information is the first information in the step S51 of FIG. 5.

In an embodiment, the trigger condition includes but not limited to at least one of: the transmission power of the UE is less than or equal to the power threshold; the UE is in the first mobility state; the transmission power of the UE is less than or equal to the power threshold and determining that the UE is in the first mobility state; or in response to determining that the service cache data volume of the UE is greater than the preset data volume.

In an embodiment, the step S51 includes: sending the first information of the UE based on the trigger condition.

The information processing method provided by the embodiments of the present disclosure is performed by the UE, which includes: in response to determining that the transmission power of the UE is less than or equal to the power threshold, sending the first information of the UE. In the embodiments of the present disclosure, the first information may include information for indicating the transmission power supported by the UE in the working mode.

The information processing method provided by the embodiments of the present disclosure is performed by the UE, which includes: in response to determining that the UE is in the first mobility state, sending the first information of the UE; where the UE in the first mobility state has a moving rate lower than a rate threshold.

The information processing method provided by the embodiments of the present disclosure is performed by the UE, which includes: in response to determining that the transmission power of the UE is less than or equal to the power threshold and determining that the UE is in the first mobility state, sending the first information of the UE.

The information processing method provided by the embodiments of the present disclosure is performed by the UE, which includes: in response to determining that the service cache data volume of the UE is greater than the preset data volume, sending the first information of the UE.

The information processing method provided by the embodiments of the present disclosure is performed by the UE, which includes: in response to determining that the transmission power of the UE is less than or equal to the power threshold and determining that the service cache data volume of the UE is greater than the preset data volume, sending the first information of the UE.

The information processing method provided by the embodiments of the present disclosure is performed by the UE, which includes: in response to determining that the transmission power of the UE is less than or equal to the power threshold, the UE is in a first mobility state, and the service cache data volume of the UE is greater than the preset data volume, sending the first information of the UE.

In an embodiment, the step S81 includes at least one of: in response to determining that the transmission power of the UE is less than or equal to the power threshold, sending the first information of the UE; in response to determining that the UE is in a first mobility state, sending the first information of the UE; where the UE in the first mobility state has a moving rate lower than the rate threshold; in response to determining that the transmission power of the UE is less than or equal to the power threshold and determining that the UE is in the first mobility state, sending the first information of the UE; or in response to determining that the service cache data volume of the UE is greater than a preset data volume, sending the first information of the UE.

In the embodiments of the present disclosure, when the UE satisfy a trigger condition, the UE may report the first information. Therefore, on the one hand, the reporting resource and the system overhead can be saved, and on the other hand, since these trigger conditions are the transmission power of the UE being less than or equal to the power threshold, the UE being in the first mobility state, and/or the service cache data volume of the UE being greater than a preset data volume, when the UE satisfies allowing the full duplexing mode, the configuration of the UE working in the full duplexing mode can be determined based on the trigger conditions. For example, when the transmission power is less than the power threshold, it indicates that isolation between transmission and reception links can avoid, as possible, the interference between the uplink and downlink transmissions, and it is appropriate for the UE to work in the full duplexing mode. For another example, when the UE is in the first mobility state, and the transmission power of the UE changes little within a time, it is also appropriate for the UE to work in the full duplexing mode. For another example, when the service cache data volume of the UE is greater than the preset data volume, it means that the UE needs to process a large data volume, and the UE needs to work in the full duplexing mode to complete service as soon as possible. When these trigger conditions are satisfied, the first information may be sent, which helps the network device to determine the configuration of the UE working in the full duplexing mode. Furthermore, the UE spectrum utilization rate can be increased and the service delay can be reduced. Further, it is extremely possible that the UE is enabled to work in the full duplexing mode when these trigger conditions are satisfied, and the first information can be sent only upon the precondition that these trigger conditions are satisfied, saving the system overhead.

It should be noted that those skilled in the arts can understand that the method provided by the embodiments of the present disclosure can be executed separately or together with some methods in the embodiments of the present disclosure or with some methods in the related arts.

There is below provided an information processing method which is performed by a network device, and its descriptions are similar to the descriptions of the above information processing method performed by the UE. Further, the technical details not disclosed in the embodiments of the information processing method performed by the network device can be referred to the descriptions of the information processing method performed by the UE, and thus no detailed descriptions are made herein.

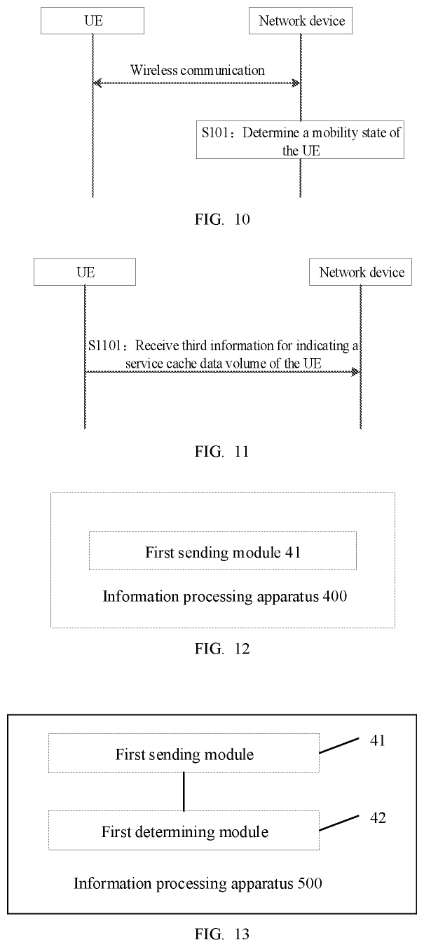

As shown in FIG. 9, there is provided an information processing method, which is performed by a network device. The method includes step S91 to S92.

At step S91, first information of a UE is received.

At step S92, configuration of a working mode of the UE is determined based on the first information, where the working mode at least includes a full duplexing mode.

In some embodiments of the present disclosure, the first information is the first information in the step S51 of FIG. 5; the working mode is the working mode in the step S51; the network device is the network device in the step S51.

In an embodiment, the first information is used at least for the configuration for the working mode of the UE by the network device.

The information processing method provided by the embodiments of the present disclosure is performed by the network device, which includes: receiving the first information of the UE from the UE.

The information processing method provided by the embodiments of the present disclosure is performed by the network device, which includes: in response to that the first information includes information allowing the full duplexing mode, determining the configuration of the UE working in the full duplexing mode.

The information processing method provided by the embodiments of the present disclosure is performed by the network device, which includes: in response to that the first information includes information disallowing the full duplexing mode, determining the configuration of the UE working in a non-full duplexing mode.

In an embodiment, the step S92 includes one of: in response to that the first information includes information allowing the full duplexing mode, determining the configuration of the UE working in the full duplexing mode; or in response to that the first information includes information disallowing the full duplexing mode, determining the configuration of the UE working in the non-full duplexing mode.

In the embodiments of the present disclosure, the network device may receive the first information of the UE, and determine the configuration for the working mode of the UE based on the first information. Thus, in the embodiments of the present disclosure, the working mode in which the UE properly works may be determined based on the first information of the duplexing mode reported by the UE. For example, if the network device determines that the first information includes information allowing the full duplexing mode, the configuration of the UE working in the full duplexing mode is determined; if the network device determines that the first information includes information disallowing the full duplexing mode, the configuration of the UE working in the non-full duplexing mode is determined. Therefore, in the embodiments of the present disclosure, whether the UE works in the full duplexing mode can be determined; if it is determined that the UE works in the full duplexing mode, it is helpful for UE to increase the frequency resource utilization rate and reduce the service delay.

In an embodiment, the first information is used to indicate a transmission power supported by the UE in the working mode.

In an embodiment, the first information indicates at least one of: a transmission power supported by the UE in the full duplexing mode; or a transmission power supported by the UE in the non-full duplexing mode.

The information processing method provided by the embodiments of the present disclosure is performed by the network device, which includes: in response to that the first information includes information allowing the full duplexing mode, and the first information indicates the transmission power being less than or equal to a power threshold, determining the configuration of the UE working in the full duplexing mode; or, in response to that the first information includes information disallowing the full duplexing mode, and/or the first information indicates the transmission power being greater than the power threshold, determining the configuration of the UE working in the non-full duplexing mode.

Illustratively, the network device receives the first information; when the network device determines that the first information includes the information allowing the full duplexing mode, and determines that the transmission power of the UE is less than or equal to the power threshold, the configuration of the UE working in the full duplexing mode is determined.

Illustratively, the network device receives the first information; when the network device determines that the first information includes the information allowing the full duplexing mode, and determines that the transmission power of the UE is greater than the power threshold, the configuration of the UE working in the non-full duplexing mode is determined.

Illustratively, the network device receives the first information; when the network device determines that the first information includes the information disallowing the full duplexing mode, and determines that the transmission power of the UE is greater than the power threshold, the configuration of the UE working in the non-full duplexing mode is determined.

In an embodiment, the step S92 includes one of: in response to that the first information includes information allowing the full duplexing mode, and the first information indicates the transmission power being less than or equal to the power threshold, determining the configuration of the UE working in the full duplexing mode; or in response to that the first information includes information disallowing the full duplexing mode, and/or the first information indicates the transmission power being greater than the power threshold, determining the configuration of the UE working in the non-full duplexing mode.

In the embodiments of the present disclosure, if the transmission power of the UE is less than or equal to the power threshold, isolation between transmission and reception links is achieved by a duplexer or the like to avoid, as possible as, the interference between uplink and downlink transmissions. In this way, it is determined that it is appropriate for the UE to work in the full duplexing mode, so as to increase the frequency resource utilization rate and reduce the service delay. If the transmission power of the UE is greater than the power threshold, when isolation between transmission and reception links is achieved by a duplexer or the like, the interference between uplink and downlink transmission is still relatively large. Thus, it is determined that it is appropriate for the UE to work in the non-full duplexing mode (even if the UE allows the full duplexing mode) to isolate the interference between uplink and downlink transmissions, thereby increasing the accuracy of uplink and downlink data transmission and the like.

It should be noted that those skilled in the arts can understand that the method provided by the embodiments of the present disclosure can be executed separately or together with some methods in the embodiments of the present disclosure or with some methods in the related arts.

As shown in FIG. 10, there is provided an information processing method which is performed by the network device. The method includes step S101.

At step S101, a mobility state of the UE is determined.

In some embodiments of the present disclosure, the mobility state is the mobility state in the step S61 of FIG. 6; the second information is the second information in the step S61.

In an embodiment, the step S101 includes receiving the second information of the UE, and determining the mobility state of the UE based on the second information.

The information processing method provided by the embodiments of the present disclosure is performed by the network device, which includes: receiving the second information of the UE, and determining the mobility state of the UE based on the second information.

In an embodiment, determining the mobility state of the UE based on the second information includes one of: if it is determined that a change value of a signal strength of a reference signal received by the UE within a preset time range is less than or equal to a threshold based on the second information, determining that the UE is in a first mobility state; or if it is determined that the change value of the signal strength of the reference signal received by the UE within the preset time range is greater than the threshold based on the second information, determining that the UE is in a second mobility state.

The information processing method provided by the embodiments of the present disclosure is performed by the network device, which includes: if it is determined that the change value of the signal strength of the reference signal received by the UE within the preset time range is less than or equal to the threshold based on the second information, determining that the UE is in the first mobility state.

The information processing method provided by the embodiments of the present disclosure is performed by the network device, which includes: if it is determined that the change value of the signal strength of the reference signal received by the UE within the preset time range is greater than the threshold based on the second information, determining that the UE is in the second mobility state.

Illustratively, the network device receives the second information from the UE, where the second information includes the signal strength of the reference signal received by the UE within the preset time range. The network device obtains a maximum value of the signal strength of the reference signal received by the UE within the preset time range and a minimum value of the signal strength of the reference signal received within the preset time range; and the network device determines a difference between the maximum value and the minimum value, and determines whether the difference is greater than a threshold. If determining that the difference is less than or equal to the threshold, the network device determines that the UE is in the first mobility state; if determining that the difference is greater than the threshold, the network device determines that the UE is in the second mobility state.

In an embodiment of the present disclosure, the network device may accurately determine the UE being in the first mobility state or in the second mobility state based on the second information from the UE.

In an embodiment, the step S101 includes: determining the mobility state of the UE based on the mobility state of the UE indicated by the second information.

The information processing method provided by the embodiments of the present disclosure is performed by the network device, which includes: determining the mobility state of the UE based on the mobility state of the UE indicated by the second information.

Illustratively, the network device receives the second information from the UE, where the second information includes information for indicating the mobility state of the UE; if the network device determines that the second information indicates the UE being in the first mobility state, the network device determines that the UE is in the first mobility state; if the network device determines that the second information indicates the UE being in the second mobility state, the network device determines that the UE is in the second mobility state.

In the embodiments of the present disclosure, the network device may directly determine the mobility state of the UE based on the information for indicating the mobility state of the UE from the UE.

In an embodiment, the step S92 includes: determining the configuration for the working mode of the UE based on the first information and the mobility state of the UE.

The information processing method provided by the embodiments of the present disclosure is performed by the network device, which includes: determining the configuration for the working mode of the UE based on the first information and the mobility state of the UE.

In an embodiment, determining the configuration for the working mode of the UE based on the first information and the mobility state of the UE includes one of:
in response to that the first information includes information allowing the full duplexing mode and the UE is in the first mobility state, determining the configuration of the UE working in the full duplexing mode; or
in response to that the first information includes information disallowing the full duplexing mode and/or the UE is in the second mobility state, determining the configuration of the UE working in the non-full duplexing mode.

The UE in the first mobility state has a moving rate less than a moving rate of the UE in the second mobility state.

The information processing method provided by the embodiments of the present disclosure is performed by the network device, which includes: in response to that the first information includes information allowing the full duplexing mode and the UE is in the first mobility state, determining the configuration of the UE working in the full duplexing mode; and/or, in response to that the first information includes information disallowing the full duplexing mode and/or the UE is in the second mobility state, determining the configuration of the UE working in the non-full duplexing mode; where the UE in the first mobility state has a moving rate less than a moving rate of the UE in the second mobility state.

Illustratively, the network device receives the first information and the second information; if determining that the first information includes information allowing the full duplexing mode, and if determining that the UE is in the first mobility state based on the second information, the network device determines the configuration of the UE working in the full duplexing mode.

Illustratively, the network device receives the first information and the second information; if determining that the first information includes information allowing the full duplexing mode, and if determining that the UE is in the second mobility state based on the second information, the network device determines the configuration of the UE working in the full duplexing mode.

Illustratively, the network device receives the first information and the second information; if determining that the first information includes information disallowing the full duplexing mode, and if determining that the UE is in the second mobility state based on the second information, the network device determines the configuration of the UE working in the full duplexing mode.

In the embodiments of the present disclosure, the network device may determine the working mode of the UE based on the first information includes information whether allowing the full duplexing mode, and the mobility state of the UE determined based on the second information. Thus, the configuration of the proper working mode of the UE can be more accurately determined.

In an embodiment determining the configuration for the working mode of the UE based on the first information and the mobility state of the UE includes one of: in response to that the first information includes information allowing the full duplexing mode, the first information indicates the transmission power being less than or equal to the power threshold and the UE is in the first mobility state, determining the configuration of the UE working in the full duplexing mode; or in response to that the first information includes information disallowing the full duplexing mode, the first information indicates the transmission power being greater than the power threshold and/or the UE is in the second mobility state, determining the configuration of the UE working in the non-full duplexing mode.

The information processing method provided by the embodiments of the present disclosure is performed by the network device, which includes: in response to that the first information includes information allowing the full duplexing mode, the first information indicates the transmission power being less than or equal to the power threshold and the UE is in the first mobility state, determining the configuration of the UE working in the full duplexing mode.

The information processing method provided by the embodiments of the present disclosure is performed by the network device, which includes: in response to that the first information includes information disallowing the full duplexing mode, the first information indicates the transmission power being greater than the power threshold and/or the UE is in the second mobility state, determining the configuration of the UE working in the non-full duplexing mode.

Therefore, in the embodiments of the present disclosure, the network device may determine the working mode of the UE based on the first information includes information whether allowing the full duplexing mode, the transmission power in the first information, and the mobility state of the UE determined based on the second information. In this way, the configuration of the proper working mode of the UE can be more accurately determined.

In an embodiment, the network device receives the first information; the network device determines the first information includes information allowing the full duplexing mode; if determining that the transmission power of the UE is less than a first power which is less than the power threshold based on the first information, and a difference between the first power and the power threshold is greater than a second power, the network device determines the transmission power of the UE is far less than the power threshold. Hence, the network device can determine the configuration of the UE working in the full duplexing mode. In the embodiments of the present disclosure, because the transmission power of the UE is very small, for example, is far less than the power threshold, the configuration of the UE working in the full duplexing mode can be determined without considering the mobility state of the UE.

In an embodiment, the network device receives the first information; the network device determines the first information includes information allowing the full duplexing mode; if determining that the transmission power of the UE is less than a third power based on the first information, and a difference between the third power and the power threshold is less than a fourth power, and the fourth power is less than the second power, the network device determines the transmission power of the UE differs little from the power threshold. If determining that the UE is in the first mobility state based on the second information, the network device determines the configuration of the UE working in the full duplexing mode; if determining that the UE is in the second mobility state based on the second information, the network device determines the configuration of the UE working in the non-full duplexing mode. Therefore, in the embodiments of the present disclosure, since the transmission power of the UE differs little from the power threshold, the mobility state of the UE may have impact on whether the transmission power of the UE exceeds the power threshold much. For example, if the UE is in the first mobility state, it means that the transmission power of the UE within a time (e.g., within a preset time range) will not change much, and the transmission power of the UE also will not exceed the power threshold much. Thus, it is still appropriate for the UE to work in the full duplexing mode, and the network device can determine the configuration of the UE working in the full duplexing mode. For another example, if the UE is determined to be in the second mobility state, it means that the transmission power of the UE within a time may change much, and the transmission power of the UE is likely to exceed the power threshold much. Therefore, it is not appropriate for the UE to work in the full duplexing mode, and the network device may determine the configuration of the UE working in the non-full duplexing mode. In this way, the network device in the embodiments of the present disclosure can more accurately determine the configuration of the proper working mode of the UE.

It should be noted that those skilled in the arts can understand that the method provided by the embodiments of the present disclosure can be executed separately or together with some methods in the embodiments of the present disclosure or with some methods in the related arts.

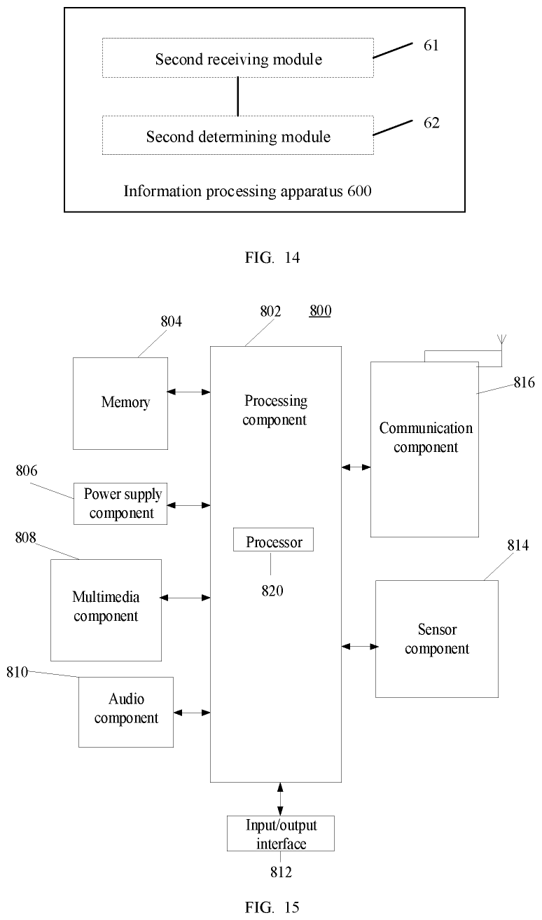

As shown in FIG. 11, there is provided an information processing method, which is performed by the network device. The method includes step S1101.

At step S1101, third information for indicating a service cache data volume of the UE is received.

In some embodiments of the present disclosure, the first information is the first information in the step S51 of FIG. 5.

In an embodiment, the step S92 includes determining the configuration for the working mode of the UE based on the first information and the third information.

The information processing method provided by the embodiments of the present disclosure is performed by the network device, which includes: determining the configuration for the working mode of the UE based on the first information and the third information.

In an embodiment, determining the configuration for the working mode of the UE based on the first information and the third information includes one of:
in response to that the first information includes information allowing the full duplexing mode and the third information indicates that the service cache data volume is greater than or equal to a preset data volume, determining the configuration of the UE working in the full duplexing mode; or
in response to that the first information includes information disallowing the full duplexing mode and/or the third information indicates the service cache data volume being less than the preset data volume, determining the configuration of the UE working in the non-full duplexing mode.

The information processing method provided by the embodiments of the present disclosure is performed by the network device, which includes: in response to that the first information includes information allowing the full duplexing mode and the third information indicates that the service cache data volume is greater than or equal to the preset data volume, determining the configuration of the UE working in the full duplexing mode.

The information processing method provided by the embodiments of the present disclosure is performed by the network device, which includes: in response to that the first information includes information disallowing the full duplexing mode and/or the third information indicates the service cache data volume being less than the preset data volume, determining the configuration of the UE working in the non-full duplexing mode.

In the embodiments of the present disclosure, when determining the service cache data volume of the UE, i.e., the data volume to be cached for the UE executing service is relatively large, the network device may determine that it is appropriate for the UE to work in the full duplexing mode. Thus, the UE can complete service as soon as possible, reducing the service delay. Alternatively, when the network device determines that the service cache data volume of the UE, i.e., the data volume to be cached for the UE executing service is relatively small, the UE can complete service as soon as possible without working in the full duplexing mode. In this way, it is determined that it is appropriate for the UE to work in the non-full duplexing mode, reducing the interference of uplink and downlink transmissions.

In an embodiment, the step S92 includes: determining the configuration for the working mode of the UE based on the first information, the second information and the third information.

The information processing method provided by the embodiments of the present disclosure is performed by the network device, which includes: determining the configuration for the working mode of the UE based on the first information, the second information and the third information.

In an embodiment, determining the configuration for the working mode of the UE based on the first information, the second information and the third information includes one of:
in response to that the first information includes information allowing the full duplexing mode, the first information indicates the transmission power being less than or equal to the power threshold, the second information indicates the UE being in the first mobility state and the third information indicates the service cache data volume being greater than the preset data volume, determining the configuration of the UE working in the full duplexing mode; or
in response to that the first information includes information disallowing the full duplexing mode, the first information indicates the transmission power being greater than the power threshold, the second information indicates the UE being in the second mobility state and/or the third information indicates the service cache data volume being less than the preset data volume, determining the configuration of the UE working in the non-full duplexing mode.

The information processing method provided by the embodiments of the present disclosure is performed by the network device, which includes: in response to that the first information includes information allowing the full duplexing mode, the first information indicates the transmission power being less than or equal to the power threshold, the second information indicates the UE being in the first mobility state and the third information indicates the service cache data volume being greater than the preset data volume, determining the configuration of the UE working in the full duplexing mode.

The information processing method provided by the embodiments of the present disclosure is performed by the network device, which includes: in response to that the first information includes information disallowing the full duplexing mode, the first information indicates the transmission power being greater than the power threshold, the second information indicates the UE being in the second mobility state and/or the third information indicates the service cache data volume being less than the preset data volume, determining the configuration of the UE working in the non-full duplexing mode.

In the embodiments of the present disclosure, the first information, the second information and the third information may be combined together to determine the configuration for the proper working mode of the UE. For example, when the conditions that the first information includes information allowing the full duplexing mode and indicates the transmission power being less than or equal to the power threshold, that the second information indicates the UE being in the first mobility state, and that the third information indicates the service cache data volume of the UE being greater than the preset data volume, are all satisfied, it is determined that it is appropriate for the UE to work in the full duplexing mode. For another example, when one of the conditions that the first information includes information disallowing the full duplexing mode, that the first information determines the transmission power being greater than the power threshold, that the second information indicates the UE being in the second mobility state and that the third information indicates the service cache data volume of the UE being less than the preset data volume, is satisfied, it is determined that it is appropriate for the UE to work in the non-full duplexing mode. Thus, in the embodiments of the present disclosure, the proper working mode of the UE can be more accurately determined.

It should be noted that those skilled in the arts can understand that the method provided by the embodiments of the present disclosure can be executed separately or together with some methods in the embodiments of the present disclosure or with some methods in the related arts.

As shown in FIG. 12, there is provided an information processing apparatus 400, which is applied to User Equipment (UE). The apparatus 400 includes a first sending module 41.

The first sending module 41 is configured to send first information of the UE, where the first information is used at least for configuration by a network device for a working mode of the UE, and the working mode at least includes a full duplexing mode.

The information processing apparatus 400 provided by the embodiments of the present disclosure is applied to the UE and includes: the first sending module 41 being configured to send the first information of the UE to a network device, where the first information is used at least for configuration by the network device for the working mode of the UE, and the working mode at least includes the full duplexing mode.

In an embodiment, the first information is used to indicate a transmission power supported by the UE in the working mode.

The information processing apparatus 400 provided by the embodiments of the present disclosure is applied to the UE and includes: the first sending module 41 being configured to send the first information of the UE, where the first information is used for configuration by the network device for the working mode of the UE, and for indicating the transmission power supported by the UE in the working mode; where the working mode at least includes the full duplexing mode.

In an embodiment, the first information indicates at least one of: a transmission power supported by the UE working in the full duplexing mode; or a transmission power supported by the UE working in a non-full duplexing mode.

The information processing apparatus 400 provided by the embodiments of the present disclosure is applied to the UE and includes: the first sending module 41 being configured to send second information for indicating a mobility state of the UE.

In an embodiment, the second information and the first information are used for configuration by the network device for the working mode of the UE.

The information processing apparatus 400 provided by the embodiments of the present disclosure is applied to the UE and includes: the first sending module 41 being configured to send third information for indicating a service cache data volume of the UE.

In an embodiment, the third information and the first information are used for configuration by the network device for the working mode of the UE.

In an embodiment, the third information, the first information and the second information are used for configuration by the network device for the working mode of the UE.

The information processing apparatus 400 provided by the embodiments of the present disclosure is applied to the UE and includes: the first sending module 41 being configured to send the first information of the UE based on a trigger condition.

The information processing apparatus 400 provided by the embodiments of the present disclosure is applied to the UE and includes: the first sending module 41 being configured to perform at least one of: in response to determining that the transmission power of the UE is less than or equal to a power threshold, sending the first information of the UE; in response to determining that the UE is in a first mobility state, sending the first information of the UE; where the UE in the first mobility state has a moving rate lower than a rate threshold; in response to determining that the transmission power of the UE is less than or equal to the power threshold and determining that the UE is in the first mobility state, sending the first information of the UE; in response to determining that the service cache data volume of the UE is greater than a preset data volume, sending the first information of the UE; in response to determining that the transmission power of the UE is less than or equal to the power threshold and the service cache data volume of the UE is greater than the preset data volume, sending the first information of the UE; or in response to determining that the transmission power of the UE is less than or equal to the power threshold, the UE is in the first mobility state, and the service cache data volume of the UE is greater than the preset data volume, sending the first information of the UE.

As shown in FIG. 13, there is provided an information processing apparatus 500, which is applied to the UE and includes the first determining module 41 and a first determining module 42. The description of the first sending module 41 is not repeated.

The first determining module 42 is configured to, if a change value of a signal strength of a reference signal received by the UE within a preset time range is less than or equal to a threshold, determine the UE being in the first mobility state.

It should be noted that those skilled in the arts can understand that the apparatus provided by the embodiments of the present disclosure can be executed separately or together with some apparatuses in the embodiments of the present disclosure or with some apparatuses in the related arts.

The specific manner in which each module in the apparatus provided by the above embodiments performs operations has been described in details in the method embodiments and will not be repeated herein.

As shown in FIG. 14, there is an information processing apparatus 600, which is applied to a network device. The apparatus includes a second receiving module 61 and a second determining module 62.

The second receiving module 61 is configured to receive first information of User Equipment (UE).

The second determining module 62 is configured to determine configuration for a working mode of the UE based on the first information; where the working mode at least includes a full duplexing mode.

The information processing apparatus 600 provided by the embodiments of the present disclosure is applied to the network device and includes: the second receiving module 61 being configured to receive the first information from the UE.

The information processing apparatus 600 provided by the embodiments of the present disclosure is applied to the network device and includes: the second determining module 62 being configured to, in response to that the first information includes information allowing the full duplexing mode, determine configuration of the UE working in the full duplexing mode; or, the second determining module 62 being configured to, in response to that the first information includes information disallowing the full duplexing mode, determine configuration of the UE working in a non-full duplexing mode.

In an embodiment, the first information is further used to indicate a transmission power supported by the UE in the working mode.

In an embodiment, the first information indicates at least one of: a transmission power supported by the UE working in the full duplexing mode; or a transmission power supported by the UE working in the non-full duplexing mode.

The information processing apparatus 600 provided by the embodiments of the present disclosure is applied to the network device and includes: the second determining module 62 being configured to, in response to that the first information includes information allowing the full duplexing mode, and the first information indicates the transmission power being less than or equal to a power threshold, determine the configuration of the UE working in the full duplexing mode; or the second determining module 62 being configured to, in response to that the first information includes information disallowing the full duplexing mode, and/or the first information indicates the transmission power being greater than the power threshold, determine the configuration of the UE working in the non-full duplexing mode.

The information processing apparatus 600 provided by the embodiments of the present disclosure is applied to the network device and includes: the second determining module 62, configured to determine a mobility state of the UE.

The information processing apparatus 600 provided by the embodiments of the present disclosure is applied to the network device and includes: the second determining module 62 being configured to determine the configuration for the working mode of the UE based on the first information and the mobility state of the UE.

The information processing apparatus 600 provided by the embodiments of the present disclosure is applied to the network device and includes: the second determining module 62 being configured to, in response to that the first information includes information allowing the full duplexing mode, and the UE is in a first mobility state, determine the configuration of the UE working in the full duplexing mode; or the second determining module 62 being configured to, in response to that the first information includes information disallowing the full duplexing mode, and/or the UE is in a second mobility state, determine the configuration of the UE working in the non-full duplexing mode. Where a moving rate of the UE in the first mobility state is less than a moving rate of the UE in the second mobility state.

The information processing apparatus 600 provided by the embodiments of the present disclosure is applied to the network device and includes: the second receiving module 61 being configured to receive second information of the UE; the second determining module 62 being configured to determine the mobility state of the UE based on the second information.

The information processing apparatus 600 provided by the embodiments of the present disclosure is applied to the network device and includes: the second determining module 62 being configured to, if it is determined that a change value of a signal strength of a reference signal received by the UE within a preset time range is less than or equal to a threshold based on the second information, determine the UE being in the first mobility state; or the second determining module 62 being configured to, if it is determined that the change value of the signal strength of the reference signal received by the UE within the preset time range is greater than the threshold based on the second information, determine the UE being in the second mobility state.

The information processing apparatus 600 provided by the embodiments of the present disclosure is applied to the network device and includes: the second determining module 62 being configured to, in response to that the first information includes information allowing the full duplexing mode, the first information indicates the transmission power being less than or equal to the power threshold, and the UE is in the first mobility state, determine the configuration of the UE working in the full duplexing mode; or the second determining module 62 being configured to, in response to that the first information includes information disallowing the full duplexing mode, the first information indicates the transmission power being greater than the power threshold, and/or the UE is in the second mobility state, determine the configuration of the UE working in the non-full duplexing mode.

The information processing apparatus 600 provided by the embodiments of the present disclosure is applied to the network device and includes: the second receiving module 61, configured to receive third information for indicating a service cache data volume of the UE.

The information processing apparatus 600 provided by the embodiments of the present disclosure is applied to the network device and includes: the second determining module 62 being configured to determine the configuration for the working mode of the UE based on the first information and the third information.

The information processing apparatus 600 provided by the embodiments of the present disclosure is applied to the network device and includes: the second determining module 62 being configured to, in response to that the first information includes information allowing the full duplexing mode and the third information indicates the service cache data volume being greater than or equal to a preset data volume, determine the configuration of the UE working in the full duplexing mode; or the second determining module 62 being configured to, in response to that the first information includes information disallowing the full duplexing mode, and/or the third information indicates the service cache data volume being less than the preset data volume, determine the configuration of the UE working in the non-full duplexing mode.

It should be noted that those skilled in the arts can understand that the apparatus provided by the embodiments of the present disclosure can be executed separately or together with some apparatuses in the embodiments of the present disclosure or with some apparatuses in the related arts.

The information processing apparatus 600 provided by the embodiments of the present disclosure is applied to the network device and includes: the second determining module 62 being configured to determine the configuration for the working mode of the UE based on the first information, the second information and the third information.

The information processing apparatus 600 provided by the embodiments of the present disclosure is applied to the network device and includes: the second determining module 62 being configured to, in response to that the first information includes information allowing the full duplexing mode, the first information indicates the transmission power being less than or equal to the power threshold, the second information indicates the UE being in the first mobility state, and the third information indicates the service cache data volume being greater than the preset data volume, determine the configuration of the UE working in the full duplexing mode; or the second determining module 62 being configured to, in response to that the first information includes information disallowing the full duplexing mode, the first information indicates the transmission power being greater than the power threshold, the second information indicates the UE being in the second mobility state, and/or the third information indicates the service cache data volume being less than the preset data volume, determine the configuration of the UE working in the non-full duplexing mode.

The specific manner in which each module in the apparatus provided by the above embodiments performs operations has been described in details in the method embodiments and will not be repeated herein.

An embodiment of the present disclosure provides a communication device, including: a processor; and a memory storing processor executable instructions. Where the processor is configured to run the executable instructions to perform the information processing method in any one of the above embodiments.

In an embodiment, the communication device may be a network device or User Equipment (UE), and the network device may be a base station or a core network device.

The processor may include any type of storage medium, which is a non-transitory computer storage medium and can continue storing information thereon after the user equipment is powered off.

The processor may be connected with the memory via a bus or the like to read executable programs stored in the memory, for example, at least one of the methods shown in FIG. 5 to FIG. 11.

An embodiment of the present disclosure provides a computer storage medium storing computer executable programs, where the executable programs are executed by a processor to perform the information processing method in any one of the above embodiments of the present disclosure, for example, at least one of the methods shown in FIG. 5 to FIG. 11.

The specific manner in which each module in the apparatus provided by the above embodiments performs operations has been described in details in the method embodiments and will not be repeated herein.

FIG. 15 is a block diagram of user equipment 800 according to an exemplary embodiment of the present disclosure. For example, the user equipment 800 may be a mobile phone, a computer, a digital broadcast user terminal, a message transceiver, a game console, a tablet device, a medical device, a fitness device, a personal digital assistant, and the like.

As shown in FIG. 15, the user equipment 800 may include one or more of the following components: a processing component 802, a memory 804, a power supply component 806, a multimedia component 808, an audio component 810, an input/output (I/O) interface 812, a sensor component 814 and a communication component 816.

The processing component 802 generally controls overall operations of the user equipment 800, such as operations associated with display, phone calls, data communications, camera operations, and recording operations. The processing component 802 may include one or more processors 820 to execute instructions to complete all or part of the steps of the above methods. In addition, the processing component 802 may include one or more modules which facilitate the interaction between the processing component 802 and other components. For example, the processing component 802 may include a multimedia module to facilitate the interaction between the multimedia component 808 and the processing component 802.

The memory 804 is configured to store various types of data to support the operation of the user equipment 800. Examples of such data include instructions for any application or method operated on the user equipment 800, contact data, phonebook data, messages, pictures, videos, and so on. The memory 804 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or compact disk.

The power supply component 806 supplies power for different components of the user equipment 800. The power supply component 806 may include a power supply management system, one or more power supplies, and other components associated with generating, managing and distributing power for the user equipment 800.

The multimedia component 808 includes a screen that provides an output interface between the user equipment 800 and a user. In some examples, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor may not only sense the boundary of touch or slide actions but also detect the duration and pressure associated with touch or slide operations. In some examples, the multimedia component 808 includes a front camera and/or a rear camera. When the user equipment 800 is in an operation mode, such as a shooting mode or a video mode, the front camera and/or the rear camera may receive external multimedia data. Each of the front and rear cameras may be a fixed optical lens system or have a focal length and an optical zoom capability.

The audio component 810 is configured to output and/or input audio signals. For example, the audio component 810 includes a microphone (MIC) configured to receive an external audio signal when the user equipment 800 is in an operation mode, such as a call mode, a recording mode, and a voice recognition mode. The received audio signal may be further stored in the memory 804 or transmitted via the communication component 816. In some examples, the audio component 810 also includes a loudspeaker for outputting an audio signal.

The I/O interface 812 provides an interface between the processing component 802 and a peripheral interface module which may be a keyboard, a click wheel, a button, or the like. These buttons may include, but are not limited to a home button, a volume button, a start button, and a lock button.

The sensor component 814 includes one or more sensors for providing a status assessment in various aspects to the user equipment 800. For example, the sensor component 814 may detect an open/closed state of the user equipment 800, and the relative positioning of the component, for example, the component is a display and a keypad of the user equipment 800. The sensor component 814 may also detect a change in position of the user equipment 800 or a component of the user equipment 800, the presence or absence of a user in contact with the user equipment 800, the orientation or acceleration/deceleration of the user equipment 800 and a change in temperature of the user equipment 800. The sensor component 814 may include a proximity sensor configured to detect the presence of nearby objects without any physical contact. The sensor component 814 may also include a light sensor, such as a CMOS or CCD image sensor, for use in imaging applications. In some examples, the sensor component 814 may also include an acceleration sensor, a gyro sensor, a magnetic sensor, a pressure sensor, or a temperature sensor.

The communication component 816 is configured to facilitate wired or wireless communication between the user equipment 800 and other devices. The user equipment 800 may access a wireless network based on a communication standard, such as WiFi, 2G or 3G, or a combination thereof. In an example, the communication component 816 receives broadcast signals or broadcast associated information from an external broadcast management system via a broadcast channel. In an example, the communication component 816 also includes a near field communication (NFC) module to facilitate short range communication. For example, the NFC module may be implemented based on a radio frequency identification (RFID) technology, an infrared data association (IrDA) technology, an ultrawideband (UWB) technology, a Bluetooth (BT) technology, and other technologies.

In an example, the user equipment 800 may be implemented by one or more of an application specific integrated circuit (ASIC), a digital signal processor (DSP), a digital signal processing device (DSPD), a programmable logic device (PLD), a field programmable gate array (FPGA), a controller, a microcontroller, a microprocessor or other electronic elements for performing the methods described herein.

In an exemplary embodiment, there is further provided a non-transitory computer readable storage medium including instructions, for example, the memory 804 including instructions, where the above instructions are executed by the processor 820 of the user equipment 800 to perform the above methods. For example, the non-transitory computer readable storage medium may be a Read Only Memory (ROM), a Random Access Memory (RAM), a CD-ROM, a magnetic tape, a floppy disk, and an optical data storage device and the like.

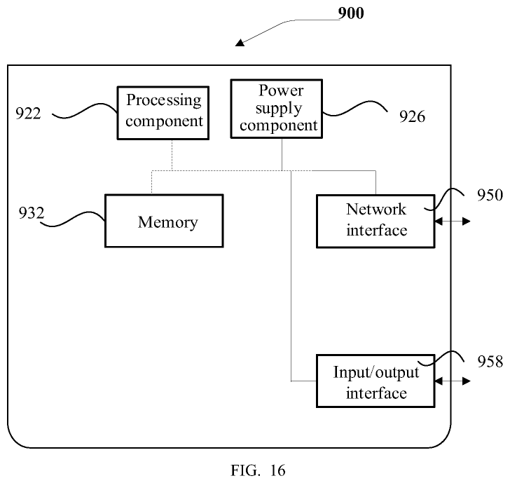

FIG. 16 shows a structure of a base station 900 according to an example of the present disclosure. For example, the base station 900 may be provided as a network side device. As shown in FIG. 16, the base station 900 may include a processing component 922 which further includes one or more processors (not shown) and memory resources represented by a memory 932 for storing instructions executable by the processing component 922, for example, an application program. The application program stored in the memory 932 may include one or more modules, each of which corresponds to one set of instructions. Further, the processing component 922 is configured to execute instructions to perform the included methods applied to the base station, for example, the methods shown in FIG. 5 to FIG. 11.

The base station 900 further includes one power supply component 926 configured to execute power management for the base station 900, one wired or wireless network interface 950 configured to connect the base station 900 to a network, and one input/output (I/O) interface 958. The base station 900 may be operated based on an operating system stored in the memory 932, such as Windows Server™, Mac OS X™, Unix™, Linux™ and FreeBSD™.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure being indicated by the following claims.

It is to be understood that the present disclosure is not limited to the precise structure described herein and shown in the accompanying drawings, and that various modifications and changes may be made without departing from the scope thereof. The scope of the present disclosure is limited only by the appended claims.

1. An information processing method, performed by User Equipment (UE), and comprising:
sending first information of the UE, wherein the first information is used for configuration by a network device for a working mode of the UE, and the working mode comprises a full duplexing mode.

2. The method of claim 1, wherein, the first information indicates at least one of:
a transmission power supported by the UE in the working mode;
the transmission power supported by the UE working in the full duplexing mode; or
the transmission power supported by the UE working in a non-full duplexing mode.

3. (canceled)

4. The method of claim 1, further comprising:
sending second information for indicating a mobility state of the UE, and
wherein the second information and the first information are used for configuration by the network device for the working mode of the UE.

5. (canceled)

6. The method of claim 1, further comprising:
sending third information for indicating a service cache data volume of the UE, and
wherein the first information and at least one of the third information or second information are used for configuration by the network device for the working mode of the UE, and the second information is configured for indicating a mobility state of the UE.

7-8. (canceled)

9. The method of claim 1, wherein sending the first information of the UE comprises:
sending the first information of the UE based on a trigger condition;
wherein sending the first information of the UE based on the trigger condition comprises at least one of:
determining that a transmission power of the UE is less than or equal to a power threshold, and sending the first information of the UE;
determining that the UE is in a first mobility state, and sending the first information of the UE; wherein the UE in the first mobility state has a moving rate lower than a rate threshold;
determining that the transmission power of the UE is less than or equal to the power threshold and determining that the UE is in the first mobility state, and sending the first information of the UE; or
determining that a service cache data volume of the UE is greater than a preset data volume, and sending the first information of the UE.

10. (canceled)

11. The method of claim 9, further comprising:
determining that a change value of a signal strength of a reference signal received by the UE within a preset time range is less than or equal to a threshold, and determining that the UE is in the first mobility state.

12. An information processing method, performed by a network device, and comprising:
receiving first information of the User Equipment (UE); and
determining configuration for a working mode of the UE based on the first information; wherein the working mode comprises a full duplexing mode.

13. The method of claim 12, wherein determining the configuration for the working mode of the UE based on the first information comprises one of:
determining that the first information comprises information allowing the full duplexing mode, and determining configuration of the UE working in the full duplexing mode; or
determining that the first information comprises information disallowing the full duplexing mode, and determining configuration of the UE working in a non-full duplexing mode.

14. The method of claim 12, wherein, the first information is used to indicate at least one of:
a transmission power supported by the UE in the working mode;
the transmission power supported by the UE working in the full duplexing mode; or
the transmission power supported by the UE working in a non-full duplexing mode.

15. (canceled)

16. The method of claim 14, wherein determining the configuration for the working mode of the UE based on the first information comprises one of:
in response that the first information comprises information allowing the full duplexing mode, and the first information indicates the transmission power being less than or equal to a power threshold, and determining the configuration of the UE working in the full duplexing mode; or
in response to that the first information comprises information disallowing the full duplexing mode, and/or the first information indicates the transmission power being greater than the power threshold, and determining the configuration of the UE working in the non-full duplexing mode.

17. The method of claim 12, further comprising:
determining a mobility state of the UE;
wherein determining the configuration for the working mode of the UE based on the first information comprises:
determining the configuration for the working mode of the UE based on the first information and the mobility state of the UE.

18. (canceled)

19. The method of claim 17, wherein determining the configuration for the working mode of the UE based on the first information and the mobility state of the UE comprises one of:
determining that the first information comprises information allowing the full duplexing mode and the UE is in a first mobility state, and determining the configuration of the UE working in the full duplexing mode; or
determining that the first information comprises information disallowing the full duplexing mode and/or the UE is in a second mobility state, and determining the configuration of the UE working in a non-full duplexing mode, and
wherein a moving rate of the UE in the first mobility state is less than a moving rate of the UE in the second mobility state.

20. The method of claim 17, wherein determining the mobility state of the UE comprises:
receiving second information of the UE; and
determining the mobility state of the UE based on the second information.

21. The method of claim 20, wherein determining the mobility state of the UE based on the second information comprises one of:
determining that a change value of a signal strength of a reference signal received by the UE within a preset time range is less than or equal to a threshold based on the second information, and determining that the UE is in the first mobility state; or
determining that the change value of the signal strength of the reference signal received by the UE within the preset time range is greater than the threshold based on the second information, and determining that the UE is in the second mobility state.

22. The method of claim 1817, wherein determining the configuration for the working mode of the UE based on the first information and the mobility state of the UE comprises one of:
determining that the first information comprises information allowing the full duplexing mode, the first information indicates a transmission power being less than or equal to a power threshold and the UE is in a first mobility state, and determining the configuration of the UE working in the full duplexing mode; or
determining that the first information comprises information disallowing the full duplexing mode, the first information indicates the transmission power being greater than the power threshold and/or the UE is in a second mobility state, and determining the configuration of the UE working in a non-full duplexing mode.

23. The method of claim 12, further comprising:
receiving third information for indicating a service cache data volume of the UE.

24. The method of claim 23, wherein determining the configuration for the working mode of the UE based on the first information comprises:
determining the configuration for the working mode of the UE based on the first information and the third information;
wherein determining the configuration for the working mode of the UE based on the first information and the third information comprises one of:
determining that the first information comprises information allowing the full duplexing mode and the third information indicates the service cache data volume being greater than or equal to a preset data volume, and determining the configuration of the UE working in the full duplexing mode; or
determining that the first information comprises information disallowing the full duplexing mode and/or the third information indicates the service cache data volume being less than the preset data volume, and determining the configuration of the UE working in a non-full duplexing mode.

25. (canceled)

26. The method of claim 23, wherein determining the configuration for the working mode of the UE based on the first information comprises:
determining the configuration for the working mode of the UE based on the first information, second information and the third information;
wherein determining the configuration for the working mode of the UE based on the first information, the second information and the third information comprises one of:
determining that the first information comprises information allowing the full duplexing mode, the first information indicates a transmission power being less than or equal to a power threshold, the second information indicates the UE being in a first mobility state and the third information indicates the service cache data volume being greater than the preset data volume, and determining the configuration of the UE working in the full duplexing mode; or
determining that the first information comprises information disallowing the full duplexing mode, the first information indicates the transmission power being greater than the power threshold, the second information indicates the UE being in the second mobility state and/or the third information indicates the service cache data volume being less than the preset data volume, and determining the configuration of the UE working in a non-full duplexing mode.

27.-54. (canceled)

55. A communication device, comprising:
a processor; and
a memory storing processor-executable instructions, wherein
the processor is configured to run the processor-executable instructions to perform operations comprising: sending first information of user equipment (UE),
the first information is used for configuration by a network device for a working mode of the UE, and
the working mode comprises a full duplexing mode.

56. (canceled)

57. A communication device, comprising:
a processor, and
a memory storing processor-executable instructions, and
wherein the processor is configured to run the processor-executable instructions to perform the information processing method of claim 12.
